(19) United States
(12) Patent Application Publication
(10) Pub. No.: US 2006/0106742 A1
(43) Pub. Date: May 18, 2006

(54) System and method for weighing and tracking freight

(75) Inventors: Joseph M. Bochicchio, Charlotte, NC (US); David J. Ridling, Salisbury, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Speed Trac Technologies, Inc.

(21) Appl. No.: 11/247,525

(22) Filed: Oct. 11, 2005

Related U.S. Application Data
(63) Continuation-in-part of application No. 10/425,203, filed on Apr. 28, 2003, now Pat. No. 6,983,883.
(60) Provisional application No. 60/376,248, filed on Apr. 29, 2002.

(51) Int. Cl. G01G 19/14

(52) U.S. Cl. 705/414; 702/174; 177/136; 177/25.13

(57) ABSTRACT

In a freight shipment system and method, the lift trucks used by the freight carrier for handling and loading freight shipments are equipped with a weighing device capable of weighing each piece of freight handled by the lift truck. The lift truck operator also has a scanner for scanning coded identification information associated with each piece of freight. As each piece of freight is handled by the lift truck, the coded identification information for that piece of freight is captured along with the weight of the load. This information is transmitted to a computer system where it can be used for real-time invoicing. The system can also obtain dimensional information about the volume of the piece of freight.

### CROSS-REFERENCE TO RELATED APPLICATIONS

This application is a continuation-in-part of application Ser. No. 10/425,203 filed Apr. 28, 2003, which in turn, claims priority from U.S. provisional application No. 60/376, 248 filed Apr. 29, 2002.

### FIELD OF THE INVENTION

This invention relates to a system and method that is useful in the freight shipment industry.

### BACKGROUND OF THE INVENTION

Typically, in the freight shipment industry, shipments of freight are received from a shipper by the freight carrier, accumulated at freight terminals where they are sorted by shipment destination and then loaded onto tractor-trailer trucks for shipment. At a receiving terminal, the shipments of freight are unloaded, and sorted for transshipment or delivery. Usually, the freight shipment is arranged on one or more pallets, and the loading and unloading is handled by lift trucks. Each shipment of freight is assigned an identifying number, and this number is used for tracking the freight from its origin to its destination.

Shipping charges are based upon the weight and the classification of the freight shipment and its weight. Typically, the weight of the shipment is provided to the freight carrier by the shipper on a bill of lading, and the shipment charges are calculated based upon the stated weight provided by the shipper. The freight carrier may conduct spot checks by reweighing selected shipments, but in most instances, the stated weight provided by the shipper is used as the basis for the freight charge, since it has not been feasible to reweigh each piece of freight handled by the freight carrier.

### SUMMARY OF THE INVENTION

The present invention is based upon the recognition that in many instances, the shipment weight provided by the shipper is understated, which can result in a significant loss of revenue to the freight carrier. The present invention provides a system and method that makes it possible to achieve real-time weighing of each freight shipment, and real-time invoicing based upon the actual weight of the shipment. The real-time invoicing provides enhanced timeliness and labor savings, and the ability to capture the actual weight of each freight shipment makes it possible to recover significant revenue that would otherwise be lost due to understated shipment weights provided by the shipper.

According to the present invention, the lift trucks used by the freight carrier for handling and loading freight shipments are equipped with a weighing device capable of weighing each piece of freight handled by the lift truck. The lift truck is also equipped with a scanner for scanning coded identifying information associated with each piece of freight. As each piece of freight is handled by the lift truck, the coded identifying information for that piece of freight is captured along with the weight of the load. This information is transmitted to a computer system where it can be used for real-time invoicing. The system of the present invention can also use the captured information to perform additional automated functions, such as tracking of shipments, freight loss control, and assisting in avoiding overloaded trucks. The system can include a handheld device that can be used by a lift truck operator for scanning the identification information from the freight. The handheld device can additionally include a camera for capturing a digital photograph of the piece of freight, and this digital photographic data can be transmitted to the computer system with the other information. The system can also include an image scanner configured for scanning a piece of freight being handled by a lift truck so as to obtain dimensional data for the piece of freight. The dimensional data can be stored in a database with the other information.

### BRIEF DESCRIPTION OF THE DRAWINGS

Some of the features and advantages of the invention having been described, others will become apparent from the detailed description which follows, and from the accompanying drawings, in which:

FIG. 1 is a schematic illustration of the system and method of weighing and tracking freight in accordance with the present invention.

FIG. 2 is a perspective view showing a lift truck equipped for weighing and tracking freight in accordance with the present invention.

FIG. 3 is a schematic representation showing the functions of the software modules present in the various computers used in the system and method of the present invention.

FIG. 4 is a perspective view showing a handheld terminal that may be used by a lift truck operator for implementing the system and method of the present invention.

FIG. 5 is a schematic flowchart depicting how a shipment of freight is transferred from a shipper's facility to a freight carrier's facility.

FIG. 6 is a schematic perspective view illustrating a system for capturing information about the size of a shipment of freight.

### DETAILED DESCRIPTION OF ILLUSTRATIVE EMBODIMENT

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

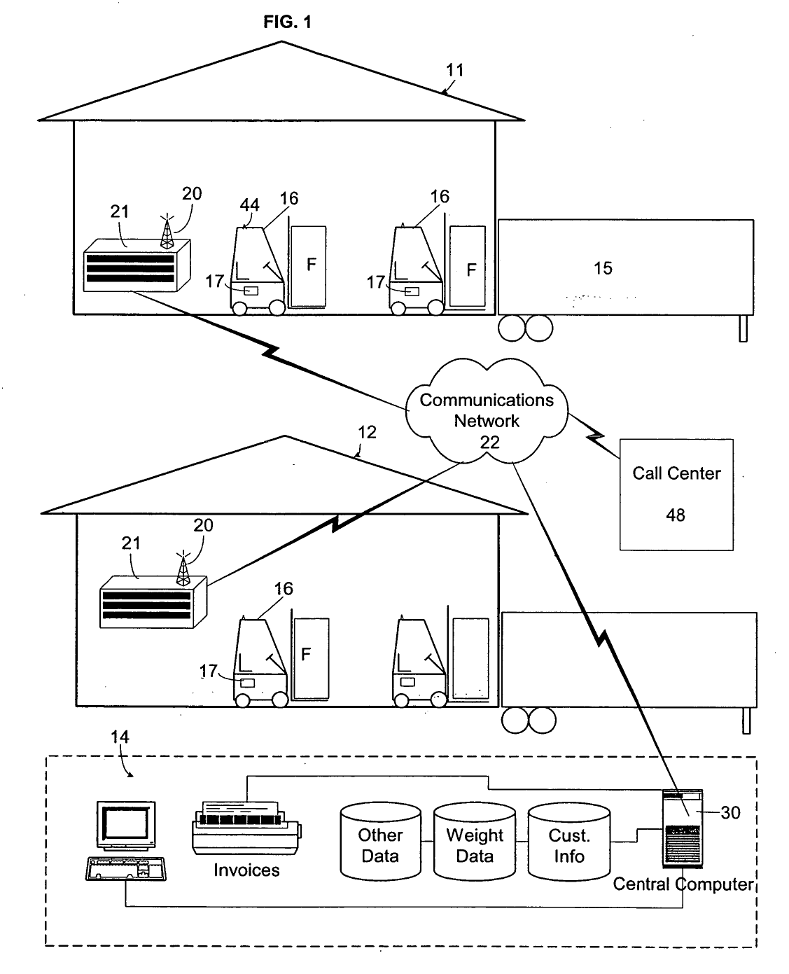

FIG. 1 is a schematic illustration of the system and method for weighing and tracking freight in accordance with the present invention. In FIG. 1 two freight terminals are shown, a first freight terminal 11, which may be located in one city, and a second freight terminal 12, which may be located in a distant city. While only two freight terminals are shown for simplicity, it will be understood that a typical freight distribution system will include many freight terminals at various different cities. The freight distribution system also includes a central office, indicated at 14, where certain business operations of the freight carrier are performed.

At each freight terminal a number of trailers 15 are arranged at a loading dock for receiving or unloading freight F. The freight is handled by lift trucks 16. In the embodiment shown, the lift trucks are conventional forklifts which are equipped with a weighing device that is capable of obtaining the weight of each piece of freight handled by the forklift. The weighing device may comprise a load cell mounted to one of the forks of the forklift. Suitable load cells for this purpose are commercially available from various sources. The load cell is capable of determining the weight of a piece of freight when the lift truck lifts the piece of freight from the ground. The load cell is of such accuracy that it can function as a “legal for trade” weighing device.

Each lift truck is also equipped with a scanner that the operator of the lift truck can use for scanning coded identifying information associated with a piece of freight. The scanner can be a conventional commercially available bar code scanner, whereby the scanner will read coded identifying information in the form of a bar code when the scanner is pointed at the bar code and activated, such as pressing a switch or pulling a trigger. In an alternative embodiment, the scanner can be a device for reading coded identifying information from a RFID tag associated with the piece of freight. In the embodiment shown, each lift truck is also equipped with a remote computer 17 and with a wireless transmitter (not shown), which may be incorporated into the housing of the computer 17, and which is connected to an antenna 44. The remote computer 17 receives weight information for a piece of freight from the weighing device and the coded identification information for that piece of freight from the scanner. This information is then transmitted by the transmitter to a receiver 20 associated with a base computer 21 located in the freight terminal. Each base computer 21 is connected via a suitable communications network 22 to a central computer 30 located at the central office 14.

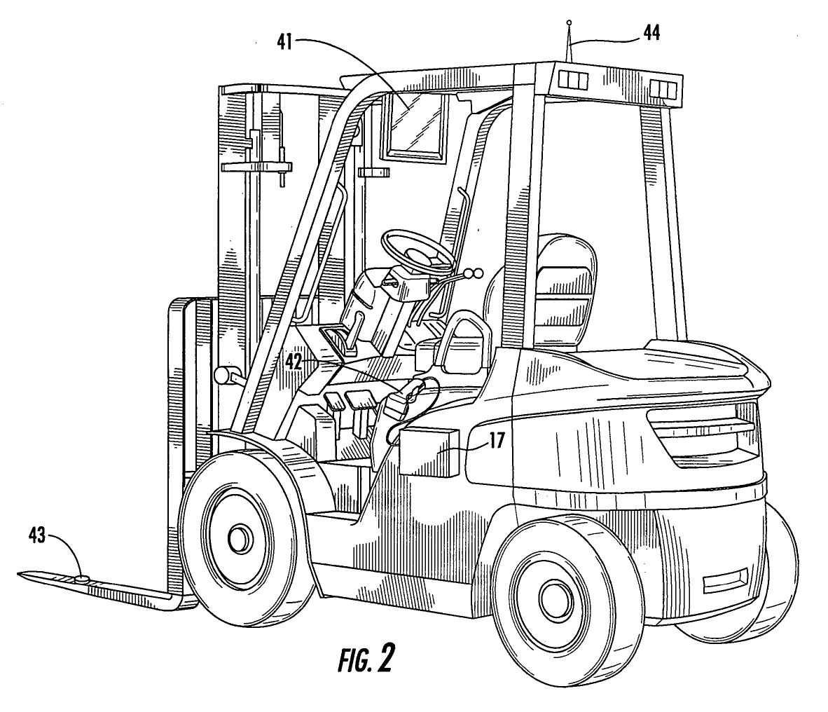

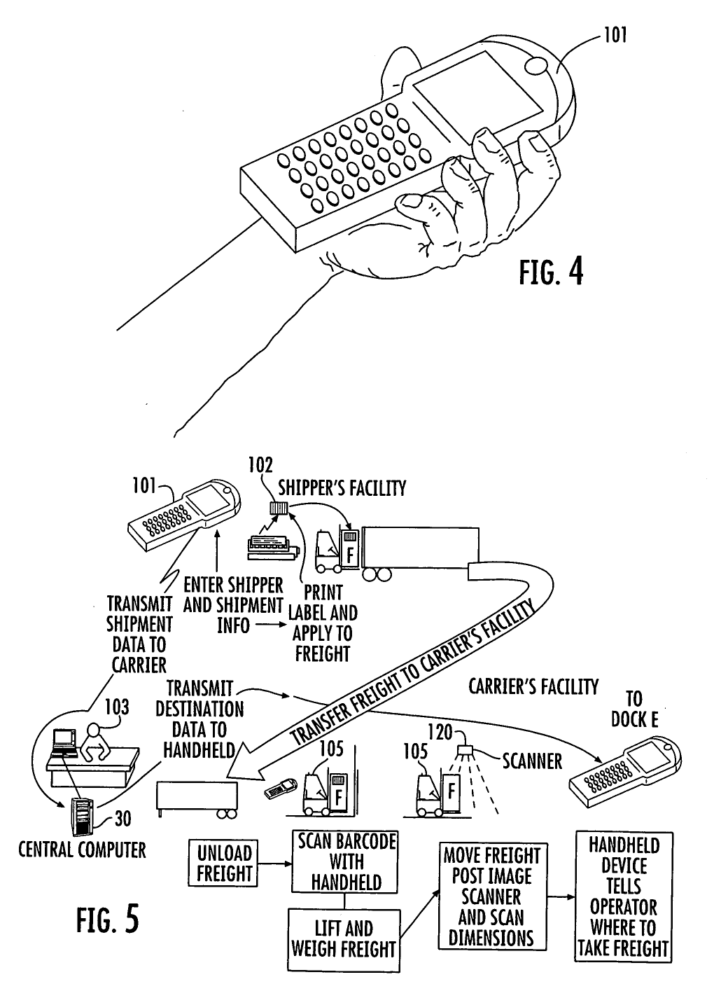

FIG. 2 illustrates one way in which the lift truck can be equipped for implementing the system and method of the present invention. In this embodiment, the remote computer 17 is mounted to the lift truck adjacent to the operator's seat. The computer 17 is equipped with a display device 41, such as a LCD display, conveniently located for displaying information to the operator of the lift truck. In the embodiment shown in FIG. 2, the display device is mounted to the roof cage of the lift truck directly in front of the lift truck driver. The display device 41 can also function as an input device for receiving commands from the lift truck operator. For example, the display device 41 can be a touch-screen device, or it can be equipped with suitable keys or buttons, such as “soft keys” that have changeable identification labels that are shown on the display device. A handheld bar code scanner 42 is connected to the computer 17 and is positioned so as to be readily accessible to the lift truck operator. A load cell 43 mounted on the fork of the lift truck is also communicatively connected to the computer 17 by wires (not shown). An antenna 44 is mounted to the roof of the lift truck and is connected to the transmitter, which is housed with the computer 17. It should be understood that this illustrated embodiment represents only one of many ways that the system and method of the present invention can be implemented. For example, in one alternative embodiment as illustrated in FIG. 4, the computer, display device, input device, transmitter, antenna, and scanner are integrated into a single handheld unit or terminal 101, and information from the load cell can be communicated to this handheld unit either by cable or by a wireless connection, such as a Bluetooth link. Alternatively, instead of transmitting information from the computer 17 or handheld device to the base computer 20 by a wireless connection, the information can simply be stored in a data storage device of the remote computer 17 or handheld device 101 and periodically downloaded to the base computer 21 by a physical connection, such as a cable or docking cradle.

The coded identifying information for a piece of freight can either be affixed directly to the piece of freight, or it can be provided on a document that is associated with the piece of freight. If it is affixed to the piece of freight, the lift truck operator will simply aim the scanner 42 or handheld unit 101 at a bar code on the piece of freight to read the coded information. It is conventional in the freight shipment industry to create a movement document that follows the freight shipment from its origin to its destination. This movement document includes the identification of the shipper, the consignee name and address, the number of pieces in the shipment, and a description of the shipment. It also has a unique freight bill number (often referred to in the industry as a “pro number”) for that shipment, and a corresponding bar code. If the movement document is used as the source of identifying information for the piece of freight, the lift truck operator will simply use the scanner 42 or handheld unit 101 to scan the identifying information from the bar code on the movement document.

The coded identifying information for the piece of freight can be generated and applied to the freight either by the shipper or by the carrier when receiving the freight shipment from the shipper. In one embodiment, as illustrated in FIG. 5 for example, a shipment of freight F is received by the freight carrier's truck driver at the shipper's loading dock. As he receives the shipment, the carrier's truck driver uses a handheld device 101 to enter information about the shipment. The handheld device is configured to receive information including, but not limited to, shipper name and address, stated weight of the shipment being shipped, number of pallets or units, a description of the freight being shipped, destination, and a product classification. The handheld device is configured to transmit this information to the carrier's central computer 30 for preparation of internal documents and scheduling of the shipment. The handheld device may, for example, transmit the information wirelessly directly to the carrier's central computer 30, as shown in FIG. 5. The carrier's driver can also produce a label 102 containing the coded identifying information and can affix this label to the freight F.

At the central office, the carrier's scheduler 103 uses the information that was transmitted by the driver for scheduling available resources for handling the shipment. The central computer system may suitably include a scheduling module which is used by the carrier's scheduling personnel in assigning the freight shipment to an outbound truck having the appropriate destination for the shipment. The handheld device 101 can include a printer, so that a bar code label is generated identifying the freight shipment. Alternatively, a printer can be located in the driver's truck. When receiving the freight shipment from the shipper, the carrier's truck driver can apply the bar code label 102 to one or more pallets or units of the freight to identify the freight shipment throughout the transit process. Alternatively, the carrier's truck driver can apply an RFID tag directly to the freight shipment, and the handheld device can be used to input identifying information about this RFID tag into the freight tracking system. The handheld device 101 used by the carrier's truck driver may also suitably include a global positioning satellite (GPS) transmitter module for transmitting information about the location of the freight pickup truck back to the central office for use by the scheduling module. This will allow the central office to determine when the pickup truck can be expected back at the central office with the freight shipments.

When the carrier's truck driver arrives at the carrier's terminal with the thus collected freight shipments, the system and method of the present invention is used to capture the actual weight of each piece of freight in the shipment. As shown in FIG. 1 for example, as each piece of freight is handled by a lift truck 16 at the carrier's origin terminal 11, the lift truck operator scans the identifying information for that piece of freight and the weight of the piece of freight is determined. The lift truck operator may, for example, use a handheld device of the type shown in FIG. 4 to scan the barcode label from the piece of freight. He also obtains the actual weight of the freight shipment from the weighing device on the lift truck. This information is transmitted to the base computer 21 and stored. The information can also be made available to the central computer 30 in the central office 14. In one specific embodiment of the present invention, this information is captured by the driver of the lift truck in a simple “lift-shoot-shoot” sequence. First the driver lifts the piece of freight so that the load cell can obtain the weight of the piece of freight. Then the driver “shoots” the coded identifying information for that piece of freight by aiming the barcode scanner at the bar code provided on the movement document for that piece of freight. Finally, the driver “shoots” another predetermined barcode in order to signify to the system that the weighing and reading sequence has been completed. This other predetermined barcode can be located at any suitable location on the lift truck, such as, for example, on the display device located in front of the lift truck driver. The reading of this barcode functions as a signal to the system to close the file and to transmit the information to the base computer 21. Each transmission to the base computer includes the following information: coded identifying information read from the movement document, total freight weight read by the load cell, forklift number, forklift operator identification, date and time, and location of the freight terminal where the information was obtained.

When the freight shipment is unloaded at the destination terminal 12, a similar “lift-shoot-shoot” procedure is followed to capture the identifying information and actual weight of each piece of freight handled at the terminal. By comparing the actual weight of a shipment at the origin terminal to the weight of the shipment at the destination terminal, a loss control module can rapidly determine whether the shipment arrived intact, or whether there was any loss or pilfering. This information can also be utilized by a tracking module to provide information on the status and location of the shipment.

The system can also include an unloading module for instructing the forklift operator on where to take the freight. After the identifying information has been scanned from the freight shipment, information from the scheduling module can be transmitted to the forklift operator's device instructing the operator where the freight should be delivered, e.g. to another trailer at the loading dock or to a particular holding and staging area within the terminal facility.

The system can also include a loading module to facilitate loading a trailer with freight. The loading module includes means for receiving information identifying the trailer into which the lift truck loads the piece of freight, and means for associating this trailer identifying information with a maximum load limit for that trailer. Each time a lift truck delivers a piece of freight to that trailer, the accumulated load weight for that trailer is determined by adding the weight of that piece of freight to the weight of all previously loaded pieces of freight. When the accumulated load weight reaches a predetermined level, in relation to the maximum load limit, a signal is generated that can be used to display information to the operator of the lift truck concerning the progress of loading, or alert the operator that the maximum load limit has been reached. The information identifying the trailer into which the piece of freight is loaded can be received in any of several ways. For example, the lift truck operator can use the scanner to scan a trailer identifying bar code located at the entrance to the trailer where the piece of freight is to be loaded. Alternatively, the trailer identification may be preassigned to a piece of freight and indicated on the movement document to inform the lift truck operator where to load the piece of freight. In this case, the scanning of the movement document will serve not only to identify the piece of freight, but also the trailer into which the piece of freight is to be loaded. Alternatively, the trailer identification can be entered manually by the operator of the lift truck using the input device associated with the computer 17, such as a touch screen, keyboard or pen.

The system can also include an optional imaging module for capturing image information about the freight shipment. A digital camera mounted either to the forklift or incorporated in the handheld device can be used to capture a digital photograph of the freight shipment. For example, when the components of the system are integrated into a single handheld unit 101, this handheld unit can also include a digital camera. Data representing a digital photograph of the freight shipment can be transmitted to the base computer along with the weight and other information obtained about the freight shipment. This information can be used by the central office as proof of shipment received, as well as to enable reviewing the shipment for appropriate product classification.

The system of the present invention can also include an optional freight volume module for obtaining the cubic dimensions of the freight shipment. One or more image scanners can be located at strategic positions within the freight terminal, such as for example at or near the loading docks of the carrier's facility. The image scanner forms a “tunnel” through which the lift truck with its load of freight must pass. As freight is removed from or loaded onto trucks at the loading dock, the lift truck carrying a shipment of freight passes through the image scanner tunnel and a three-dimensional scan of the freight is obtained. From this scan, it is possible to determine the length, width and height dimensions of the freight shipment and to determine the cubic volume of the freight shipment. The cubic volume data then passes to the central computing system along with the other information obtained about the freight shipment.

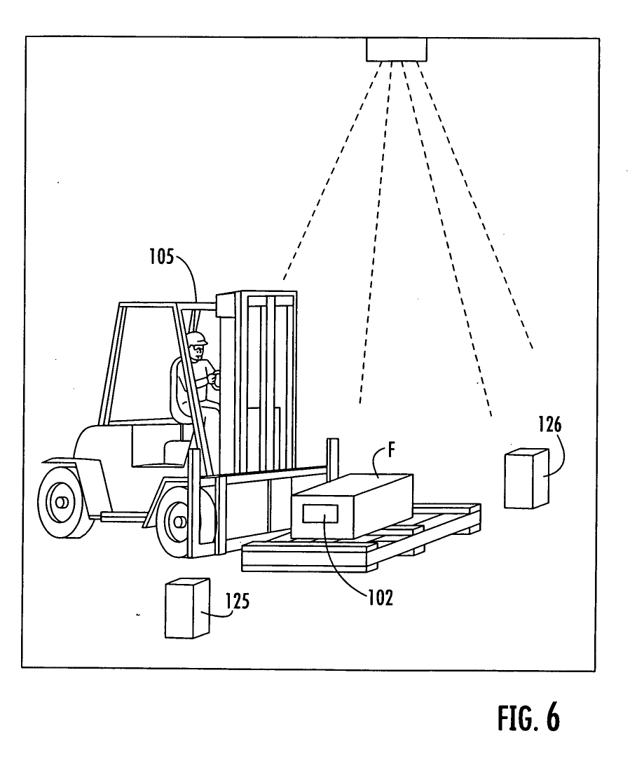

In the embodiment shown in FIG. 6, the freight volume module includes a three dimensional laser scanning head 120 mounted overhead so that the lift truck with its load of freight must pass beneath it. Laser scanning heads of this type are commercially available from various sources. The data from the scan head 120 is sent to a processor where the data is processed to ascertain the volume of the freight shipment. For example, this processing operation can distinguish between known or constant volumes, such as the pallet, so that only the volume of the freight shipment is obtained. This information is then correlated to the specific freight shipment being handled by the lift truck and is stored in a database along with the other information about that freight shipment. The identity of the particular freight shipment can be determined in any of several ways. For example, the bar code label on the piece of freight could be utilized to identify the particular freight shipment. Alternatively, the identity of the lift truck could be ascertained using a bar code or RFID tag associated with the lift truck and read by a suitably positioned reader 125 located in the vicinity of the scanning head, and this information, coupled with the real-time information in the database, could identify the particular freight shipment being handled by the lift truck at that time. The system can also include a device 126, such as a photocell or proximity switch, for identifying when a lift truck moves into the field of view of the scan head 120 and signaling the scan head 120 to initiate a scan.

In one alternative, the system can include algorithms to flag certain freight shipments as exceptions based upon a predetermined set of parameters. This will enable the freight carrier's personnel to manage and inspect the freight by the generation of exception items that require further review. In one configuration, for example, the shipper's standard industrial classification (SIC) code and other shipper data will be used by a database to determine whether the shipment is within a certain set of possible product classifications depending upon the shipper's product lines.

With the addition of the photograph and cubic volume data, as well as the actual weight of the freight as determined by the forklift-mounted scale, all components of the freight bill are then known, namely: distance, as determined by point of origin and destination; weight and cubic volume, which can be used in verifying product classification; and a photograph of the freight, which can be used to determine other characteristics of the freight that may affect product classification. Distance will be calculated by a central database of known distances between a certain point of origin and a certain point of destination, actual weight will be determined by the weighting system, cubic volume will be determined by the system for dimensioning freight, and a photograph will be reviewed to ensure that the description of the freight and other characteristics are correct before the file is submitted to a central billing system for production of the invoice to the shipper.

The system can further include a maintenance module to assist in monitoring maintenance of the lift trucks. The remote computer 17 on each lift truck can receive status information from the lift truck such as, for example, the number of hours of operation, or any status messages generated by sensors on the lift truck or by a engine control computer module for the lift truck. This information can be used by the central computer 30 for scheduling routine preventive maintenance of the lift trucks or for dispatching a service call.

The system can also include a human resources module for collecting and monitoring information for use by the human resources department of the freight carrier. The human resources module may, for example, require the lift truck operator to log in each time he begins operating the lift truck. In this way, the system can track information about which driver handled each piece of freight in a shipment, driver operating time on the lift truck, number of freight pieces handled, or other information. The collected information can be transmitted to the central computer for use in generating payroll information, work assignments, or for historical purposes.

The system can also include a customer service module which will allow customer service representatives to view the real-time data about freight shipments and to thus provide customers with status and location information about shipments. The customer service representatives can be located at a call center 48 and may access the information via the communications network 22.

The system and method of the present invention is designed to be integrated into the existing freight tracking and invoicing infrastructure of a freight carrier, and supplements the carrier's existing computerized invoicing software. The following description of a typical freight carrier's freight tracking and invoicing functions should provide contextual understanding of how the present invention is implemented and used.

A freight shipment cycle begins when the freight carrier receives a request from a shipper, by telephone or internet, for a freight pickup. The freight carrier will assign a shipment number (pro number) to this shipment, and will instruct a truck driver to pick up the shipment. Typically, the following minimum information is obtained: consignee name and address, stated weight of the shipment and payment information. This information may be provided by telephone, or more typically on a bill of lading prepared by the shipper and given to the truck driver for the freight carrier. Upon receipt of this information, the freight carrier assigns a shipment number (pro number) for this particular shipment. The shipment number may, for example, be attached as a sticker to the bill of lading furnished by the shipper, in which case this bill of lading will function as the movement document. The shipment number may also be represented by a computer readable bar code. Typically, the truck driver will add information to the movement document, such as number of pieces (shipping units) and a description of the shipment, if not already provided.

Upon returning to the freight terminal with the shipments, a data entry clerk updates the freight carrier's computer system with information about the collected shipments, including the information, if any, manually added by the driver, such as number of pieces in the shipment. A further movement document may be generated with this updated information, to be used either in addition to (e.g. stapled to the original bill of lading) or in lieu of the bill of lading furnished by the shipper. The movement document will follow the shipment until its destination.

At this point, the freight carrier's accounting system has all the information needed to generate an invoice for the shipment. The conventional system will generate an invoice at a suitable time using, as a basis for the shipping charges, the stated weight provided by the shipper. The present invention integrates with the existing accounting and invoicing system and provides the capability to update the data record for each shipment or pro number with a real-time actual weight for the shipment. The invoicing module in the central computer uses the thus-captured identifying information and real-time actual weight data to generate customer invoices. The invoices are based upon the actual weight for each piece of freight shipped, rather can an estimate of the shipment weight. The freight carrier's standard accounting software can utilize the information to generate the customer invoices using customer information stored in a database.

Information maintained by the system of the present invention can be made available to authorized users through conventional hard-wired networks, wireless networks, virtual private networks, through web access, or other suitable networking methods.

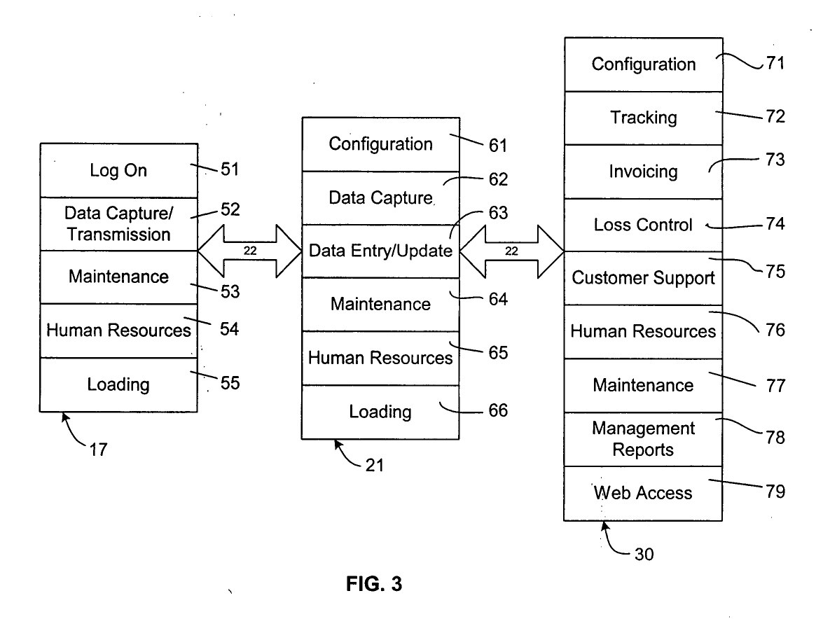

FIG. 3 illustrates one possible configuration for the software modules that facilitate implementation of the system and method of the present invention. It will be understood by those familiar with computer software that various other implementations are possible and within the scope of the present invention. In this embodiment, software modules are resident in the remote computer 17 that is located on the lift truck, in the base computer 21 at the freight terminal, and in the central computer 30 at the central business office of the freight carrier. These modules process, receive and share information as needed to carry out their assigned tasks or functions.

In the remote computer 17, a log on module 51 captures the lift truck operator identification at the beginning of a shift, as well as the time and date of log in and log out. It additionally may capture the number of lifts made by the operator. The data capture and transmission module 52 captures the identifying information for a shipment from the scanner and the weight of the shipment from the load cell, and controls transmission of this information to the base computer 21. The maintenance module 53 maintains pertinent maintenance information such as total running time, number of lifts, etc. and passes this information to the base computer 21. The human resources module 54 coordinates sending pertinent information about the lift truck operator to the base computer 21, such as the log in and log out times and dates. The loading module 55 facilitates receiving information about which trailer a shipment is loaded into, and displaying information to the lift truck operator about the status of loading that trailer, such as cumulative weight loaded onto the trailer or whether the maximum weight limit for that trailer is being approached or has been exceeded.

At the base computer 21, a configuration module 61 controls the basic configuration and “housekeeping” functions of system. A data capture module 62 receives and stores the data transmitted from the lift trucks 16 in the terminal. A data entry and update module 63 allows for entry and updating of information by a data entry clerk. A maintenance module 64 receives and administers the maintenance information from the maintenance modules 53 of the respective lift trucks. Likewise, the human resources module 65 receives and administers human resources information from the human resource modules 54 of the respective lift trucks. A loading module 66 interfaces with the loading modules 55 on the respective lift trucks.

At the central computer 30, a configuration module 71 controls the basic configuration and “housekeeping” functions of the system. A tracking module 72 utilizes the time and date stamp data and location data that is generated by a lift truck each time a shipment is handled to trace the progress of the shipment and its current location. An invoicing module 73 makes available to the freight carrier's standard invoicing software, the actual weight of each shipment. A loss control module 74 compares the actual weight of a shipment at one location (e.g. its origin) with the actual weight of the same shipment at another location (e.g. its destination) to identify if there is any variance. A customer support module 75 gives a customer support representative access to pertinent information, such as tracking information, invoicing information, etc. A human resources module 76 coordinates the information obtained by the human resource modules 54 and 65, and a maintenance module 77 coordinates the information from the maintenance modules 53, 64. A management reports module 78 has access to all of the accumulated data obtained by the system and is capable of displaying or printing various kinds of management information. A web access module 79 provides for uploading selected subsets of the data stored on the central computer to a web host to allow for remote web access by authorized users. The various functions such as customer support, human resources and maintenance may, if desired, be accessed remotely via web access rather than through a direct network connection.

Table 1 below shows the fields of information that are maintained in the system, and the fields that are used by the various modules.

TABLE 1

| | | | | | | | | | | | Key | Key | |
|---|---|---|---|---|---|---|---|---|---|---|---|---|---|
| | Pro | | | | Operator | Forklift | Number | Stated | Actual | | On | off | Lifts by |
| Module | Number | Location | Date | Time | ID | Number | Pieces | Weight | Weight | Variance | Time | Time | Operator |
| Data | X | X | X | X | X | X | | | X | | | | |
| Capture/ | | | | | | | | | | | | | |
| Transmission | | | | | | | | | | | | | |
| Data Entry/ | X | | X | | | | X | X | | | | | |
| Update | | | | | | | | | | | | | |
| Invoicing | X | X | X | X | X | X | X | X | X | X | | | |
| Maintenance | | X | X | X | X | X | | | | | X | X | X |
| Loss | X | X | X | X | X | | X | X | X | X | | | |
| Recovery | | | | | | | | | | | | | |
| Human | | X | X | X | X | X | X | | | | | | X |
| Resources | | | | | | | | | | | | | |
| Management | X | X | X | X | X | X | X | X | X | X | X | X | X |
| View | | | | | | | | | | | | | |

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A system for weighing and tracking freight comprising:
identification information associated with each of a plurality of pieces of freight, the identification information being adapted to follow the piece of freight as it is transported by a freight carrier from an origin to a destination;
a lift truck equipped for lifting and moving a piece of freight;
a weighing device associated with the lift truck for obtaining the weight of the freight;
a scanner accessible to an operator of the lift truck for scanning the identification information associated with the piece of freight;
a base computer cooperating with the scanner for receiving the identification information for the piece of freight and cooperating with the weighing device for receiving the weight of the piece of freight; and
a database associated with said base computer for receiving and storing the weight data and identification information for the freight.

2. The system of claim 1, wherein the identification information is a barcode affixed to the piece of freight.

3. The system of claim 1, wherein the identification information is an RFID tag affixed to the piece of freight.

4. The system of claim 1, including a handheld device accessible to the operator of the lift truck, and wherein said scanner is mounted in said handheld device, the handheld device communicating with said weighing device for receiving weight data obtained for a piece of freight, and said handheld device including a wireless transmitter communicatively connected to the weighing device and to the scanner and operable for transmitting weight data and identification information obtained for the piece of freight to a receiving site.

5. The system of claim 4, wherein said handheld device additionally includes a camera for capturing a digital photograph of the piece of freight, and wherein said wireless transmitter is also communicatively connected to the camera for transmitting digital photographic data for the piece of freight to a receiving site.

6. The system of claim 1, additionally including an image scanner configured for scanning a piece of freight held by said lift truck and for obtaining dimensional data for the piece of freight.

7. The system of claim 6, wherein said database includes means for storing the dimensional data for the piece of freight in addition to the weight data and identification information for the freight.

8. The system of claim 7, including an invoicing module operable for generating customer invoices based upon the weight data and identifying information obtained by said lift truck and the dimensional data.

9. A system for weighing and tracking freight comprising:
a lift truck equipped for lifting and moving a piece of freight;
a weighing device associated with the lift truck for obtaining the weight of the freight;
a scanner accessible to an operator of the lift truck for scanning the identifying information associated with the piece of freight;
an image scanner configured for scanning a piece of freight held by said lift truck and for obtaining dimensional data for the piece of freight;
a base computer cooperating with the scanner for receiving the identifying information for the piece of freight, cooperating with the weighing device for receiving the weight of the piece of freight, and cooperating with the image scanner for receiving dimensional data for the piece of freight; and
a database associated with said base computer for receiving and storing the weight data, the identifying information and the dimensional data for the freight.

10. The system of claim 9, additionally including a camera for capturing a digital photograph of the piece of freight, and wherein said database is also operable for storing digital photographic data for the piece of freight.

11. A system for weighing and tracking freight comprising:
identification information associated with each of a plurality of pieces of freight, the identification information being intended to follow the piece of freight as it is transported by a freight carrier from an origin to a destination;
a lift truck equipped for lifting and moving a piece of freight;
a weighing device associated with the lift truck for obtaining the weight of the freight;
a handheld device accessible to an operator of the lift truck, the handheld device being communicatively connected to the weighing device for receiving weight data for the piece of freight, and the handheld device including a scanner for scanning the identification information associated with the piece of freight;
a base computer cooperating with the scanner for receiving the identification information for the piece of freight and cooperating with the weighing device for receiving the weight of the piece of freight; and
a database associated with said base computer for receiving and storing the weight data and identification information for the freight.

12. The system of claim 11, including a wireless transmitter for transmitting weight data and identification information obtained for the piece of freight to a receiving site.

13. The system of claim 11, including a memory device in the handheld device for receiving and storing weight data and identification information for pieces of freight handed by the lift truck, and means for transferring the stored weight data and identification information from the memory device in the handheld device to said database.

14. The system of claim 13, wherein said means for transfer comprises a docking station communicatively connected to said base computer and adapted to be connected to the handheld device for downloading the stored data from the memory device.

15. The system of claim 11, including a display in the handheld device for communicating information to the driver of the lift truck.

16. The system of claim 15, including an unloading module cooperating with the handheld device and operable for displaying to the driver of the lift truck a location where the piece of freight should be unloaded.

17. The system of claim 11, including a bar code printer associated with the handheld device and operable for producing a label containing the identification information.

18. A method for weighing and tracking freight comprising:
equipping a lift truck with a weighing device capable of obtaining the weight of each piece of freight handled by the lift truck;
scanning coded identifying information associated with a piece of freight in connection with the handling of the piece of freight by the lift truck;
using the weighting device to obtain weight data for the piece of freight handled by the lift truck;
obtaining dimensional data for the piece of freight handled by the lift truck; and
storing the thus obtained weight data, dimensional data and identifying information for the piece of freight.

19. The method of claim 18, wherein the step of scanning coded identifying information comprises scanning a barcode on a label associated with the piece of freight.

20. The method of claim 19, wherein the step of scanning coded identifying information comprises scanning the barcode using a handheld scanning device.

21. The method of claim 20, including wirelessly transmitting the weight data, dimensional data and identifying information for the piece of freight from the handheld device to a receiving site and storing the data.

22. The method of claim 20, including storing the weight data, dimensional data and identifying information for the piece of freight in a memory device in the handheld device and transferring the stored weight data, dimensional data and identifying information from the memory device in the handheld device to a database.

23. The method of claim 18, additionally including capturing a digital photograph of the piece of freight, and also storing digital photographic data for the piece of freight.

24. The method of claim 18, wherein the step of obtaining dimensional data for the piece of freight handled by the lift truck comprises passing the freight through the field of view of an image scanner and obtaining a three-dimensional scan the piece of freight from which the cubic volume of the freight can be determined.

25. A method for weighing and tracking freight comprising:
equipping a lift truck with a weighing device capable of obtaining the weight of each piece of freight handled by the lift truck;
providing the operator of the lift truck with a wireless handheld scanning device;
scanning coded identifying information associated with a piece of freight with the wireless handheld scanning device in connection with the handling of the piece of freight by the lift truck;
using the weighting device to obtain weight data for the piece of freight handled by the lift truck; and
wirelessly transmitting the identifying information and the weight data to a remote receiving site.

26. The method of claim 25, including displaying on the display of the handheld device a location where the piece of freight should be unloaded.
